(19) United States
(12) Patent Application Publication
(10) Pub. No.: US 2024/0280694 A1
(43) Pub. Date: Aug. 22, 2024

(54) MINIMIZING THE LATENCY OF A TARGET'S RESPONSE TO A SONAR TRANSMISSION

(71) Applicant: RTsys, CAUDAN (FR)

(72) Inventor: Samuel ANTOINE, Lorient (FR)

(21) Appl. No.: 18/443,277

(22) Filed: Feb. 15, 2024

(30) Foreign Application Priority Data
Feb. 16, 2023 (FR) 2301456

(51) Int. Cl. G01S 15/74

(52) U.S. Cl. CPC G01S 15/74

(57) ABSTRACT

An submarine target device comprising an acoustic receiver, an acoustic transmitter and processing means adapted to perform a first cycle of operations comprising detecting within an acoustic stream captured by the acoustic receiver, the start of a first signal corresponding to characteristics of at least one acoustic transmitter remote from at least one detector; triggering the recording of the first signal; detecting, within the acoustic stream, the end of the first signal and triggering the cessation of recording; then a second cycle of operations comprising detecting, within the acoustic stream, the start of a second signal corresponding to said characteristics; and triggering the transmission of the first signal, via the acoustic transmitter.

### CROSS-REFERENCE TO RELATED APPLICATIONS

The present application claims priority to French Application No. 2301456 filed with the Intellectual Property Office of France on Feb. 16, 2023, which is incorporated herein by reference in their entirety for all purposes.

### TECHNICAL FIELD

The present disclosure relates to a target for anti-submarine warfare training. It applies in particular to minimizing the latency of such a target's response to a sonar emission.

### BACKGROUND

A crucial step in anti-submarine warfare is to detect the presence and, if possible, the trajectory of submarine vessels using sonar.

One difficulty is that submarines have variable signatures, which designers seek to reduce in order to make them as undetectable as possible. As a result, the signal-to-noise ratio of a sonar echo can be quite low, due to ambient noise, including that caused by the vessel carrying the sonar and responsible for submarine detection.

In order to improve anti-submarine warfare performance, personnel must be extremely well trained in the handling of detection equipment, and acquire substantial experience. In addition, the detection devices themselves (sonar and digital processing software) must be constantly adapted and improved to guarantee the required levels of performance.

Today's submarine training targets are generally autonomous underwater vehicles that can be remotely programmed or piloted to carry out a mission, and include devices to simulate a response corresponding to that of a conventional submarine vessel to the reception of a sonar signal. In fact, being substantially smaller in size than a conventional submarine vessel (capable of carrying personnel), they cannot provide a sufficient passive response for their detection, or, in any case, their response is very weak compared with such a submarine vessel.

Training targets are therefore equipped with devices for simulating the response using an acoustic transmitter.

Some targets are equipped with an acoustic transmitter and receiver positioned on the hull.

If the transmitter comes into operation when the target registers the acoustic signal, it is disturbed by the re-transmission. Also, according to the state of the art, the transmitter and receiver do not operate simultaneously: when a sonar transmission reaches the target, it records the entire sonar transmission. When it detects the end of the transmission, it re-transmits the recorded signal so as to simulate a sonar echo such as would have been obtained with a conventionally-sized submarine vessel.

However, such targets are problematic, as they have an excessively long latency time between the transmission of a signal by the detection device and its reception. Since the target has to wait for the entire signal to be received before it can be retransmitted, reception of the retransmitted signal by the detector is delayed by the same amount of time. In addition, recent sonars tend to use increasingly longer signals. Detectors determine the distance to a detected target by the time taken for the transmitted signal to return. As a result, the estimate of the target's distance will be distorted. Such a target is therefore not conducive to effective training of submarine vessel detection personnel.

Other types of target feature a transmitter on the hull and a towed antenna. Such an arrangement makes it possible to simultaneously analyze the received signal and issue a response.

When an acoustic signal reaches the target, it continuously records, analyzes and responds to the incoming signal. As soon as a response is calculated for a portion of the signal, it is transmitted without waiting for the complete acoustic signal to finish.

But such a solution only partially solves the latency problem: latency no longer depends on the duration of the signal, but on the time taken to calculate the response.

In particular, minimizing the latency time that distorts the estimation of the distance between the target and the detection device implies a strong constraint on the computing power of the target and on the precision of filtering operations (size of FIR filters, etc.).

The addition of a towed antenna is also a major constraint:
target deployment and recovery is more complex;
the drag generated by the antenna prevents high speeds from being reached and greatly reduces the target's autonomy;
the addition of an antenna represents a significant cost.

Prior art training targets therefore have various drawbacks which hamper their performance and effective use.

### SUMMARY

A submarine target device is disclosed which at least partially alleviates the above-mentioned drawbacks. In particular, the disclosure aims to minimize the latency of the response of a submarine training target to an acoustic emission, in particular a sonar. In specific embodiments, the disclosure aims to provide a submarine target enabling this latency time to be reduced compared with existing targets, while retaining or improving target speed, lightness and manufacturing cost characteristics.

To this end, according to a first aspect, the present disclosure can be implemented by device for a submarine target, the device comprising an acoustic receiver, an acoustic transmitter and processing means adapted to perform a first cycle of operations comprising:
detection, within an acoustic stream captured by said acoustic receiver, of the start of a first acoustic signal corresponding to characteristics of at least one acoustic transmitter remote from at least one detector;
following detection of the start of said first signal, triggering recording of said first signal;
detection of the end of said first signal within said acoustic stream;
following detection of the end of said first signal, stopping recording of said first signal;
followed by a second cycle of operations comprising:
detection, within said acoustic stream, of the start of a second acoustic signal of the same nature as the first signal and corresponding to said characteristics; and following detection of the start of said second signal, triggering transmission, via said acoustic transmitter, of the first signal recorded during the first cycle of operations.

According to preferred embodiments, the disclosure comprises one or more of the following features which may be used separately or in partial combination with each other or in total combination with each other:
said second cycle is iterated several times, preferably 5 times;
said processing means are adapted to detect first and second signals corresponding to characteristics of a plurality of acoustic receivers distant from distinct detectors;
said processing means comprise an analog-to-digital converter for converting said acoustic stream into a series of digital samples, digital circuits for processing said series of digital samples, a digital-to-analog converter for converting said series of digital samples into an analog signal and an amplifier for amplifying said analog signal prior to its transmission via said acoustic transmitter;
said digital circuits are adapted to transform said digital samples in the frequency domain and to detect a start of a signal according to a comparison of a power for each frequency with at least one threshold;
said digital circuits are adapted to perform a first decimation of said series, by a first constant factor, then, to perform a second decimation of said series, by a factor depending on a bandwidth corresponding to said characteristics of said at least one remote acoustic transmitter.

According to a second aspect, the disclosure can also be implemented by an submarine target comprising a device as previously defined.

According to another aspect, the disclosure can also be implemented by a system comprising at least one submarine target as previously defined and at least one detector.

According to another aspect, a method is disclosed for a submarine target comprising an acoustic receiver and an acoustic transmitter, said method comprising a first cycle of operations comprising
detection, within an acoustic stream captured by said acoustic receiver, of the start of a first acoustic signal corresponding to characteristics of at least one acoustic transmitter remote from at least one detector;
following detection of the start of said first signal, triggering recording of said first signal;
detection of the end of said first signal within said acoustic stream;
following detection of the end of said first signal, stopping recording of said first signal;
followed by a second cycle of operations comprising:
detection, within said acoustic stream, of the start of a second acoustic signal of the same nature as the first signal and corresponding to said characteristics; and following detection of the start of said second signal, triggering transmission, via said acoustic transmitter, of the first signal recorded during the first cycle of operations.

According to another aspect, a computer program is disclosed comprising instructions which, when executed by a processor of a submarine target cause the submarine target to perform a method previously disclosed.

Another aspect relates to a recording medium, for example a non-transitory recording medium, on which instructions are recorded which, when executed by a submarine target, cause the submarine target to perform the process as previously defined.

The means as referred to herein may include circuitry configured to perform one or more or all steps of the disclosed method. The circuitry may be dedicated circuitry. The means may also include at least one processor and at least one memory including computer program code configured to cause the submarine target to perform one or more or all steps of the disclosed method.

The device and method described in this document do not require any specific programming of the detector, since they do not use any specific signal or any specific signal processing technology. The solution is therefore compatible with the use of standard detectors, i.e. the same detectors as those used in operation. The solution described here offers great flexibility of use.

Further features and advantages of the disclosed solution will become apparent from the following description of a preferred embodiment of the present disclosure, given by way of example and with reference to the appended drawings.

### BRIEF DESCRIPTION OF FIGURES

The appended drawings illustrate the device and method as disclosed herein:

FIG. 1 schematically represents an example of context in which embodiments can be implemented.

FIG. 2 shows a schematic state machine according to an embodiment.

FIG. 3 illustrates an example of how the processing means work.

FIG. 4 illustrates a possible functional architecture for the processing means.

FIG. 5 illustrates a possible functional architecture for digital circuits.

### DETAILED DESCRIPTION OF EMBODIMENTS

A training target can be an autonomous underwater vehicle. These targets can be programmable and/or remotely controlled by an operator. The target is designed to pick up acoustic signals of the type used by active sonar detectors, simulate a response corresponding to a conventional submarine vessel and transmit it for capture by the (sonar) detectors.

It should be noted that a training target is typically substantially smaller in size than a conventional submarine vessel. This is because it doesn't need to carry personnel, and should be less expensive in terms of manufacturing and operating costs. Also, natively, the response of such a target is very different from that of a conventional submarine vessel, and does not allow for personnel training.

The acoustic sensor is typically a sonar (acronym for “sound navigation and ranging”). This is a device that uses the special properties of sound propagation in water to detect and locate underwater objects, indicating their direction and distance. In particular, in the context of the present disclosure, an active sonar can be used, i.e. one that emits an acoustic signal and then analyzes the response, or “echo”, of any targets in the aquatic environment.

Analysis of these responses requires both appropriate technical resources and human resources trained in handling these technical resources and analyzing the responses as presented by the technical resources.

The training targets enable these personnel to be trained both in the use of detection tools in near-real conditions, and in the interpretation of the results provided by these tools. The challenge is to detect all submarine targets (minimizing false negatives) while avoiding false detections (minimizing false positives).

An example of a training target is the SEMA MK-II target from the company RTsys. It simulates the acoustic signature of a submarine vessel, and responds to active sonars, including the latest-generation TBF1 sonars and torpedo homing heads. It can descend to a depth of 300 meters and navigate for around 1.5 hours at 15 knots. This means she can immerse training crews in a realistic operational scenario, and surprise them with kinematic evasions.

With a length of around 2 meters and a weight of around 33 kilograms, it is easy to handle, deploy at sea and retrieve from any type of craft (from zodiacs to frigates). FIG. 1 shows the general context of the present disclosure.

An submarine target 1 is deployed and in operation. Operators (military or civilian personnel) use a sensor 2, such as active sonar, to try and detect the submarine target 1.

Detector 2 includes a remote acoustic transmitter 21 adapted to emit an acoustic signal according to certain characteristics. These characteristics include the characterization of a frequency band. The emission may also vary in power, duration, etc.

Generally speaking, a detector 2 transmits a signal repeatedly, in order to monitor the behavior (particularly the movement) of submarine vessels, and to maximize detection rates. However, some signals do not provide sufficient echoes for detection, and it is therefore important to have redundancy, by transmitting several signals over time, in order to maximize the probability of obtaining an echo. Analysis of the different responses obtained over time also provides additional information, such as direction or speed of movement.

The submarine target includes an acoustic receiver 11 adapted to capture an acoustic stream 31.

This acoustic stream 31 may comprise the acoustic signal 30 emitted by the remote transmitter 21, with attenuation and distortion related to the distance and relative speeds of the target 1 and detector 2. If they are too far apart, the acoustic stream will no longer contain any detectable signals from the remote transmitter 21.

According to some embodiments, several detectors may be provided, including several active (sonar) detectors. In which case, the acoustic stream 31 captured by the acoustic receiver 11 may comprise different signals emitted by these detectors.

The target 1 also contains processing means 10 adapted to analyze the acoustic stream captured by the acoustic receiver 11, and, if necessary, trigger the emission of an acoustic response 32 via an acoustic transmitter 16.

This acoustic response 32 is determined so as to form an echo similar to what an submarine vessel would have provided passively (i.e. by simple reverberation of the acoustic signal 31 on the hull). This emitted response 32 is therefore similar in form (frequency and duration) to the captured signal 31, but the levels cannot be compared as they have different reference units (dBre1 μPa² for the received level and dBre1 μPa²m² for the re-emitted level.

The output amplification level may depend on the type of submarine to be simulated.

In particular, the processing means 10 are adapted to detect within the acoustic stream 31 received by the acoustic receiver 11 the start of a first signal which corresponds to characteristics of a remote acoustic transmitter 21.

Here corresponding to the characteristics of a remote acoustic transmitter shall be understood as meaning that the particular signal to be detected corresponds to that which could be emitted by an acoustic transmitter, such as sonar. It is therefore a question of searching for such a signal to the exclusion of other types of signal that may be received by receiver 11, which may be of natural or artificial origin (noise from the target's engine, noise linked to the target's movement in the aquatic environment, etc.).

In addition, the characteristics of the remote acoustic transmitter 21 may include the frequency band used by it, so that the processing means 10 can be adapted to seek to detect the start of signals in this frequency band.

Where several remote acoustic transmitters are provided, processing means 10 can be adapted to seek to detect the start of signals in the respective frequency bands.

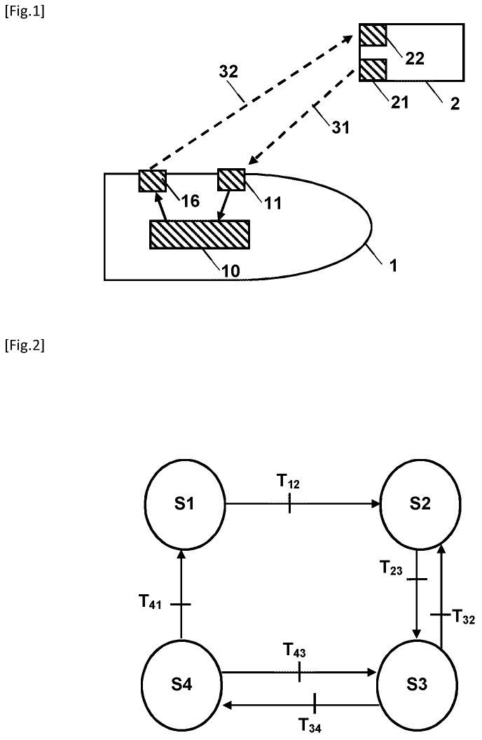

FIG. 2 illustrates a schematic state machine which, according to an embodiment, can represent the operation of processing means 10.

State S1 corresponds to this state of detecting the start of a signal in a captured acoustic stream.

When the start of a signal is detected, transition T₁₂ is triggered and processing means 10 enter state S2.

In this S2 state, recording of the detected signal is initiated. The signal is stored in a memory in the submarine target 1.

In this same state S2, the processing means 10 seek to detect the end of this signal within the acoustic stream 31.

Detection of the end of this signal triggers the T₂₃ transition, moving the detection means into an S3 state.

States S1 and S2 form a first cycle of operations aimed at capturing the signal from a detector and recording it. During this cycle, the target emits no response.

States S3 and S4 form a second cycle of operations aimed at sending a response to the remote detector. During this cycle, the target no longer analyzes the acoustic stream arriving at receiver 11.

In state S3, processing means 10 seek to detect, within acoustic stream 31, the start of a second signal corresponding to the characteristics of a remote acoustic transmitter.

This step is similar to that of state S1, and the detection means essentially seek to detect a signal of the same nature. The terms “first” and “second” are only used to distinguish them in the following discussion, and relate solely to the use made of their detection by the processing means.

The transition T₃₄ corresponds to the detection of the start of a (second) signal corresponding to the characteristics of a remote acoustic transmitter. These characteristics correspond to those of the first signal and are as previously described. Once the start of the signal has been detected (leading to validation of this transition T₃₄), the processing means enter a state S4.

In an embodiment, the processing means may detect a signal different from the signal already recorded. In this case, the processing means return to state S2 (T₃₂ transition enabled) and record the new signal in place of the previous one, then wait, in state S3, for this signal to be repeated.

In state S4, the processing means may no longer analyze the acoustic stream 31 received and shall trigger the emission of the first signal stored during the first cycle of operation, and more precisely in state S2 of the processing means.

To do this, the processing means 10 transmit the stored signal to the acoustic transmitter 16, which transmits an acoustic stream 32 into the aquatic environment. This signal corresponds to a simulated echo of the signal emitted by the detector 2's remote acoustic transmitter 21. The detector also includes a receiver 22 adapted to receive acoustic streams and analyze them for such a signal 32. In this way, the detector 2 can detect the presence of an submarine vessel simulated by the submarine target.

This second operation cycle can be repeated a predefined number of times.

In a limit case, it is iterated only once, i.e., following the retransmission of a stored signal, the processing means validate the transition T₄₁ and pass into the S1 state corresponding to the first cycle of operation. In this case, the target stores every other signal and transmits a stored signal every other signal detection.

In a preferred case, the second cycle is repeated 5 times, before a new first cycle of operations is triggered again.

According to an embodiment, in state S4, detection means 10 increment a counter. When the stored signal is transmitted, this counter is tested. If it is less than a predefined number (e.g. 5), transition T₄₃ is enabled and the processing means return to state S3 to wait for a new start of the second signal. If the predefined number is reached, then transition T₄₁ is enabled and the processing means return to state S1 to wait for the start of a first signal (for storage).

On the one hand, the periodic triggering of the first cycle of operations enables the signal received from detector 2 to be refreshed, as the signal may change over time, and it is important to maintain the match between the simulated echo and the signal. On the other hand, too many refreshes of this signal would mechanically generate a smaller number of simulated echo transmissions, and would adversely affect the detection of this echo by detector 2. The number of 5 retransmissions of the stored signal before refreshment by new storage represents an optimum compromise determined by experimentation.

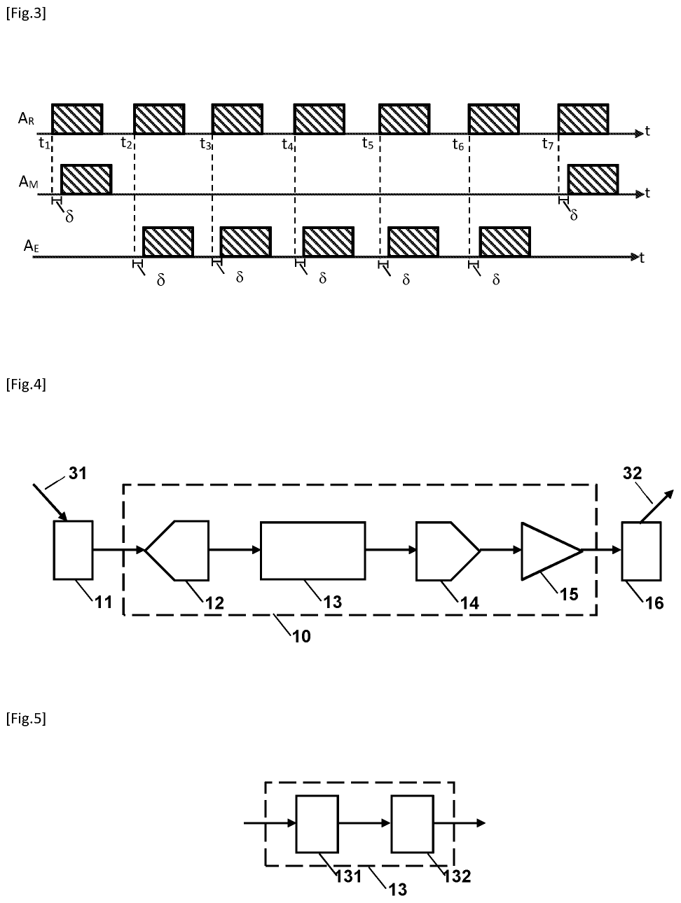

FIG. 3 illustrates an example of the operation of processing means 10, focusing on a reception activity, A_{R}, a storage activity, A_{M}, and a transmission activity A_{E}. FIG. 3 illustrates three chronograms corresponding to these activities running in parallel, with the horizontal axes representing time t.

Receiving activity A_{R} represents the incoming acoustic stream, i.e. captured by receiver 11 and supplied to processing means 10 for analysis. The storage activity A_{M} represents the storage of a (first) signal detected by the acquisition means (in step S2 in the example of FIG. 2). The transmission activity A_{E} represents the transmission of a stored signal to the acoustic transmitter 16 (in step S4 in the example of FIG. 2).

It is assumed that the processing means have not yet detected any acoustic signals and are therefore in a state corresponding to state S1 in the example shown in FIG. 2.

At time t₁, a signal begins to be received. The processing means 10 analyze the incoming acoustic stream and detect the start of this signal, triggering its storage at time t₁+d. The duration d corresponds to the time required for the processing means to analyze the incoming acoustic stream and detect the start of the signal.

The processing means analyze the incoming stream to detect the end of the signal and interrupt storage.

At this point, the first cycle of operations ends and the second cycle of operations begins.

At time t₂, a new signal is received. At time t₂+d (latency time d is assumed to be constant, for clarity), processing means 10 start transmitting the stored signal via acoustic transmitter 16.

In this example, the second cycle of operations is iterated 5 times.

Similarly, at times t₃, t₄, t₅, t₆, new signals are received. At t₃+d, t₄+d, t₅+d, t₆+d, the processing means 10 begin to transmit the stored signal via the acoustic transmitter 16.

At time t₇, a new signal is received. But as the number of iterations for the second cycle of operations has been reached, a new first cycle of operations begins.

Processing means 10 analyze the incoming acoustic stream and detect the start of this signal, triggering its storage at time t₇+d.

The process can continue with a second cycle of operations, which can be iterated 5 more times, and so on.

According to the present disclosure, first cycles are alternated during which the target captures the acoustic streams and does not itself emit any acoustic signal, and second cycles during which, on the contrary, it emits an acoustic response (simulating an echo of a signal previously detected within the acoustic streams) but does not analyze the acoustic streams, nor memorize the signals received.

Thus, in the example shown in FIG. 3, it can be seen that out of 6 signals emitted by the detector 2 and received by the target 1, five responses are emitted by the latter and likely to be picked up by the detector 2.

This principle of not trying to analyze all the acoustic streams received, and of transmitting a simulated echo of a previously received signal when a new signal is received, significantly improves performance compared with state-of-the-art solutions.

Through experimentation, the inventors have determined that not responding to all the signals received (those corresponding to the first cycle) does not cause any major inconvenience. Indeed, in real-life conditions, propagation conditions in the aquatic environment are such that, in any case, a significant proportion of sonar echoes are not received or detected by the sonars.

FIG. 4 illustrates a possible functional architecture for processing means 10.

According to this embodiment, the processing means 10 comprise an analog-to-digital converter 12 for converting the acoustic stream from the acoustic receiver 11 into a series of digital samples, digital circuitry 13 for processing this series, and a digital-to-analog converter 14 for converting this series into an analog signal for transmission via the acoustic transmitter 16. The processing means 10 may further comprise an amplifier 15 for amplifying the analog signal prior to transmission via the transmitter 16.

In an embodiment, these processing means (10) can be implemented by an electronic card adapted to be embedded in the submarine training target. The target thus comprises a watertight housing in which this card can be embedded.

This electronic board can perform the following functions:
analog-to-digital conversion of the signal received by the acoustic receiver;
provide the computing and memory resources required for the processing algorithm, as for example set out above with reference to FIGS. 2 and 3;
perform digital-to-analog conversion of the response.

The signal can then be transmitted to the voltage amplifier 15 for the acoustic transmitter 16.

In an embodiment, the electronic board may include an analog-to-digital converter operating at 10 MHz. The data is then processed by digital circuits 13.

In an embodiment, the digital circuits may comprise a processor associated with a memory storing software instructions for implementing the signal processing algorithm to be described.

In an embodiment, as illustrated in FIG. 5, the digital circuitry 13 may comprise a programmable logic circuit 131, or more specifically a field-programmable gate array (FPGA), and a digital signal processor 132 (DSP). The DSP may be responsible for implementing the algorithm described above, and calculating the target response.

In an embodiment, the programmable logic circuit can be in charge of a preliminary decimation step associated with anti-aliasing filtering. This decimation can be performed by a constant, predetermined factor. For example, a factor of 128 can be used. In an embodiment, data is transmitted from the programmable logic circuit 131 to the digital signal processor 132 in blocks of constant size. This size may, for example, be 128 samples.

Receipt of a block triggers a new analysis cycle by the digital signal processor 132. At each analysis cycle, processor 132 determines the presence or absence of a sonar signal. A strong constraint is that this analysis must be performed before a new block is received, in order to guarantee real-time analysis of the acoustic stream 31 and minimize latency time d.

The response calculated by the digital circuits 13 can then be transformed by the digital-to-analog converter.

In a preferred embodiment, this electronic board is dedicated to the processing algorithm, which is therefore not interrupted by competing processes.

In addition, the DSP 132 processor has optimized signal processing functions and can therefore guarantee that one block of data is processed before the next block is recorded (real time). According to an embodiment, a data block consists of 128 samples and therefore corresponds to 1.7 ms.

The algorithm has two main functions:
detect the beginning and end of a signal within an acoustic stream, and thus enable, in particular, its recording; and,
manage the response logic, i.e. schedule the recording cycles of a detected signal and the emission cycles of a recorded signal.

In particular, according to an embodiment, a first step consists in isolating the frequency band in which the signal to be detected is located.

In fact, the target (or, more precisely, the target processing means) can be configured according to the detection device 2 used for its detection. In this way, the target can be adapted to the equipment and conditions in place for personnel training. Indeed, each detection device can work on a frequency specific to the device for the emission of acoustic signals and, in order to best simulate an adequate response, the target may need to know this frequency which is specific to it, as well as any other parameters characterizing the signal.

In an embodiment, the target can simultaneously process several signals from detectors 2 with non-overlapping frequency bands.

To optimize the detection of submarine vessels, it makes sense to deploy several sensors. For example, in the case of a fleet of vessels, each may be equipped with a sonar sensor.

In such situations, the target can provide simulated echoes for each of the sonar detectors in operation.

The user of the training target can configure the frequency bands corresponding to these different sonar detectors. In particular, a number of detectors, Nᵥₒᵢₑₛ, can be defined, as well as for each frequency band, or channel, corresponding to a detector, a center frequency f_{c} and a bandwidth bw.

The processing means (and in particular the processor 132 according to an embodiment) are adapted to detect first and second signals corresponding to characteristics of a plurality of remote acoustic receivers 21 of distinct detectors 2. They are adapted to perform these analyses for each channel in the time imposed by the reception of the data blocks transmitted by the programmable logic circuit 131.

The received data stream is analyzed to isolate data that may correspond to signals that match the characteristics of the remote acoustic emitter(s). In practical terms, this involves detecting the start (and then the end) of a sonar-type signal within the received data stream.

In an embodiment, a frequency analysis can be performed since the center frequency and bandwidth are known for each remote acoustic transmitter.

So, for example, as soon as a block of samples is received, for each channel (i.e. remote acoustic transmitter), the samples are modulated by a complex sinusoidal signal of frequency −fc in order to center the useful frequency band on zero. The result is N_{channels} modulated signals, which can then be processed in parallel.

For example, an acoustic stream may contain signals from 3 separate acoustic transmitters. A first acoustic transmitter emits sonar signals in a frequency band with center frequency fc1 and width bw1, a second acoustic transmitter emits sonar signals in a frequency band with center frequency fc2 and width bw2, and the third acoustic transmitter emits sonar signals in a frequency band with center frequency fc3 and width bw3.

The modulated signals corresponding to each frequency band are then decimated and filtered by a polyphase filter.

Decimation consists in sub-sampling the incoming samples to keep only a part of them.

A polyphase filter is a filter set up after decimation. In particular, it aims to avoid spectrum aliasing associated with decimation, and is implemented after decimation to reduce computations and improve efficiency.

Polyphase filters are well known to the skilled person and explained in the literature. See, for example, the following Wikipedia page: https://en.wikipedia.org/wiki/Polyphase_quadrature_filter

Typically, this is a low-pass finite impulse response filter. Finite Impulse Response (FIR) filters are filters whose impulse response is of finite duration. A digital FIR filter is characterized by a response based solely on a finite number of input signal values. Consequently, whatever the filter, its impulse response will be stable and of finite duration, depending on the number of filter coefficients. The terms “non-recursive filter” or “moving-average filter” are sometimes used to refer to the same class of filters, although the term moving-average filter primarily refers to low-pass filters.

The decimation factor depends on the bandwidth. This is because the wider the bandwidth, the less decimation is possible due to the low-pass anti-aliasing filter. So, the wider the bandwidth, the lower the decimation factor.

One of the advantages of this decimation is that it reduces the volume of data to be manipulated in subsequent stages and stored in memory. As with any embedded system, memory sizing is a major constraint for the submarine target. Also, in order to store the signal to be echoed by the target, it is important that it occupies as little space as possible. This is all the more important when several channels need to be managed, corresponding to as many remote detectors 2. The decimation factor is therefore a compromise between the need to save memory and the need not to lose the frequency information of the processed signals, especially for wide frequency bands.

The acoustic streams received by the acoustic receiver 11 include noise components and (possibly) signals emitted by remote transmitters 21.

Each time a new block of data is received, for each frequency band, the modulated and filtered acoustic streams are analyzed over a period of time. The analysis focuses on the most recently recorded samples. The algorithm calculates the average power of the signal, and compares this to a detection threshold.

If in a frequency band, the average signal power over the analysis time is above the detection threshold, the algorithm treats the signal from this frequency band as coming from a distant acoustic transmitter:
either the processing means are in a first cycle of operations, and the signal has been stored in a memory associated with the processing means 10;
or the processing means are in a second cycle of operation and the previously stored signal is to be output.

Thanks to the decimation described above, a stored signal occupies a reduced data volume, in line with the constraints of embedded systems.

The detection threshold is chosen to be sufficiently high so that noise components do not generate false detections, so that only signals emitted by remote transmitters 21 generate detections.

The transmission can include processing symmetrical to that applied between the reception of the acoustic stream and its storage in the embedded memory.

In particular, the signal can be interpolated to restore the initial sampling before decimation.

Each channel can be modulated with a complex sinusoidal signal of the respective center frequency f_{c}, using a polyphase filter, in order to reconstitute the original signal. The signal can then be fed to the digital-to-analog converter 14 and, if required, to an amplifier 15 to give it the amplitude corresponding to a realistic echo that can be perceived by the remote acoustic receiver 22.

The signal can then be emitted by an acoustic transmitter 16. This acoustic signal propagates, in the conventional way, in the aquatic environment and can be received by a remote acoustic receiver 22, belonging to detector 2. The detector can thus detect the presence of the training target and interpret it as an submarine vessel.

The present disclosure enables a low latency time, so that the time between the transmission of a signal by the remote acoustic transmitter 21 and the reception of its simulated echo by the remote acoustic receiver 22 forms a very good approximation of the time it would actually have taken to transmit the signal and its echo from a real submarine vessel. As a result, a good estimate of the distance between the submarine target 1 and the detector 2 can be deduced from this time. This good estimate enables users of detector 2 to accurately trace the position and movements of the training target simulating an submarine vessel.

The present disclosure is not limited to the examples and embodiments described and shown, but is defined by the claims. In particular, it is susceptible to numerous variants accessible to those skilled in the art.

1. A submarine target device comprising an acoustic receiver, an acoustic transmitter and processing means adapted to perform a first cycle of operations comprising:
detection within an acoustic stream captured by said acoustic receiver, of the start of a first acoustic signal corresponding to characteristics of at least one remote acoustic transmitter of at least one detector;
following detection of the start of said first signal, triggering recording of said first signal;
detection within said acoustic stream of the end of said first signal;
following detection of the end of said first signal, stopping recording of said first signal;
followed by a second cycle of operations comprising:
detection within said acoustic stream, of the start of a second acoustic signal of the same nature as the first signal and corresponding to said characteristics; and following detection of the start of said second signal, triggering transmission via said acoustic transmitter of the first signal recorded during the first cycle of operations.

2. A device as claimed in claim 1, wherein said second cycle is iterated several times, preferably 5 times.

3. A device as claimed in claim 1, wherein said processing means are adapted to detect first and second signals corresponding to characteristics of a plurality of remote acoustic receivers of distinct detectors.

4. A device as claimed in claim 1, wherein said processing means comprise an analog-to-digital converter for converting said acoustic stream into a series of digital samples, digital circuits for processing said series, a digital-to-analog converter for converting said series into an analog signal and an amplifier for amplifying said analog signal prior to its transmission via said acoustic transmitter.

5. A device as claimed in claim 1, wherein said digital circuits are adapted to transform said digital samples in the frequency domain and to detect a start of the first or second signal according to a comparison of a power for each frequency with at least one threshold.

6. Device as claimed in claim 3, wherein said digital circuits are adapted to:
perform a first decimation of said series, by a first constant factor,
then, perform a second decimation of said series, by a factor depending on a bandwidth corresponding to said characteristics of said at least one remote acoustic transmitter.

7. A submarine target comprising a device according to claim 1.

8. A system comprising at least one submarine target as claimed in claim 1 and at least one detector.

9. A method for an submarine target comprising an acoustic receiver and an acoustic transmitter, said method comprising a first cycle of operations comprising:
detection, within an acoustic stream captured by said acoustic receiver, of the start of a first acoustic signal corresponding to characteristics of at least one acoustic transmitter remote from at least one detector;
following detection of the start of said first signal, triggering recording of said first signal;
detection of the end of said first signal within said acoustic stream;
following detection of the end of said first signal, stopping recording of said first signal;
followed by a second cycle of operations comprising:
detection, within said acoustic stream, of the start of a second acoustic signal of the same nature as the first signal and corresponding to said characteristics; and following detection of the start of said second signal, triggering transmission, via said acoustic transmitter, of the first signal recorded during the first cycle of operations.

10. A method as claimed in claim 9, wherein said second cycle is iterated several times, preferably 5 times.

11. A computer program comprising instructions which when executed by a processor of a submarine target, cause the submarine target to perform the claim as claimed in claim 9.

12. A non-transitory recording medium storing instructions which when executed by a processor of a submarine target, cause the submarine target to perform the claim as claimed in claim 9.
